(19) United States
(12) Patent Application Publication
(10) Pub. No.: US 2003/0223027 A1
(43) Pub. Date: Dec. 4, 2003

(54) Method of simultaneously fabricating a photospacer and a bump

(75) Inventors: Ching-Yih Chen, Miaoli (TW); Chih-Ming Lai, Hsinchu (TW)

Correspondence Address: QUINTERO LAW OFFICE, 1617 BROADWAY, 3RD FLOOR, SANTA MONICA, CA, 90404, US

(73) Assignee: Industrial Technology Research Institute

(21) Appl. No.: 10/413,259

(22) Filed: Apr. 14, 2003

(30) Foreign Application Priority Data
Apr. 18, 2002 (TW) 91107974

(51) Int. Cl. G02F 1/1337

(52) U.S. Cl. 349/129

(57) ABSTRACT

A method of simultaneously fabricating a photospacer and a bump applicable on a substrate with a photoresist layer formed thereon. A photomask is provided with a first mask pattern and a second mask pattern thereon, wherein the first mask pattern for the formation of the bump includes a plurality of light-shielding units constituting a first shape, and the second mask pattern for the formation of the photospacer is composed of a light-shielding pattern with a second shape. The photomask is then applied on the photoresist layer to perform photolithography, thereby fabricating the photospacer and the bump simultaneously. According to the method, only one photolithography step is required to fabricate the photospacer and bump of different thickness, such that yield is increased and cost is lowered.

### BACKGROUND OF THE INVENTION

1. Field of the Invention

The present invention relates to a method of simultaneously fabricating a photospacer and a bump.

1. Description of the Related Art

In the conventional manufacturing process for liquid crystal displays (LCD), photoresist in commonly used to fabricate a spacer, called a photospacer. Owing to the height of photo-spacer having a large difference from the bump used in multi-domain vertical alignment-type (MVA) LCDs, at least two steps (two exposure steps or even two exposure-development steps) are required to form the photo-spacer and bumps together in the LCD panel, thus resulting in higher costs and lower yield.

In conventional design of MVA type LCDs, bumps are formed at both upper and lower substrates of an LCD panel to control the alignment of liquid crystals and divide the alignment area thereof. As in FIG. 1, the bump 112 at upper substrate 110 and bump 102 at lower substrate 100 together restrict the disclination line of liquid crystal molecules' 120 arrangement thereon such that a dark line does not appear on the display area. Moreover, bumps also reduce the divided display area such that the on-off reaction speed of liquid crystal molecules is accelerated. Even so, disadvantages of the bumps being formed at both upper and lower substrates include reduction of yield, increased cost, and misalignment of bumps during constitution of upper and lower substrates, and increased risk of RDC when the bumps are formed over the ITO (indium tin oxide) layer.

To control liquid crystal off state, Δn*d(n represents optical anisotropic properties when d is the gap between the upper and lower substrates) is generally adjusted to achieve the best off-state mode, however, the Δn values of the same liquid crystals do not always stay the same when exposed to lights of different wavelengths, thus adjustment of merely parameter “d” does not provide best off-state modes for red, green, and blue at the same time, which results in poor color purity. Therefore, to present the best off-state modes for red, green, and blue, different gaps, for example, d_{R}, d_{G}, and d_{B} are formed corresponding to different colors. Fabricating techniques of inconsistent gap panel presently provided are all, however, very complicated.

Furthermore, in the manufacturing process for conventional transflective LCD, a problem is encountered when choosing whether the color filter used is transparent or reflective mode. If a transparent-mode color filter is used, the light reflected via the reflecting area after one pass through the color filter will have to pass therethrough again, such that the intensity of the reflected light is greatly reduced. If the reflective-mode color filter is used, the colors displayed in the transparent area are thinner and not bright enough.

### SUMMARY OF THE INVENTION

Accordingly, an object of the invention is to provide a method of simultaneously fabricating a photospacer and a bump applicable on a substrate with a photoresist layer formed thereon, comprising providing a photomask having a first mask pattern and a second mask pattern, wherein the first mask pattern for the formation of the bump comprises a plurality of light-shielding units constituting a first shape, and the second mask pattern for the formation of the photospacer is composed of a light-shielding pattern with a second shape, and applying the photomask to perform photolithography on the photoresist layer.

Another object of the invention is to provide a photomask applicable on a substrate with a photoresist layer formed thereon, to simultaneously fabricate a photospacer and a bump. The photomask comprises a photomask body, a first mask pattern for the formation of the bump comprising a plurality of light-shielding units constituting a first shape, and a second mask pattern for the formation of the photospacer composed of a light-shielding pattern with a second shape.

According to the method and photomask presented above, only one photolithography step is required to fabricate the photospacer and bump of different thickness, such that yield is increased and cost is lowered.

Another object of the invention is to provide a method of simultaneously fabricating a convex bump and a concave bump having a flat area therebetween, applicable on a substrate with a photoresist layer formed thereon. The method comprises providing a photomask having a first mask pattern for the formation of the convex bump having a first shape, a second mask pattern for the formation of the concave bump having a second shape, and a third mask pattern for the formation of the flat area having a third shape, and applying the photomask to perform photolithography on the photoresist layer.

Another object of the invention is to provide a photomask applicable on a substrate with a photoresist layer formed thereon, to simultaneously fabricate a convex bump, a concave bump, and a flat area therebetween. The photomask comprises a photomask body, a first mask pattern having a first shape for the formation of the convex bump, a second mask pattern having a second shape for the formation of the concave bump, and a third mask pattern having a third shape for the formation of the flat area.

According to the method and photomask presented above, only one photolithography step is required to fabricate the convex bump and concave bump having opposite protruding parts on a single substrate. Compared to the conventional method, the presented method increases yield, lowers coats, and solves misalignment problems normally associated with bumps.

Another object of the invention is to provide a method of simultaneously fabricating a dual convex bump and concave bump applicable on a substrate with a photoresist layer formed thereon, comprising providing a photomask having a first mask pattern and a second mask pattern, wherein the first mask pattern for the formation of the convex bump has a first shape and the second mask pattern for the formation of the concave bump has a second shape, and applying the photomask to perform photolithography on the photoresist layer.

Another object of the invention is to provide a photomask applicable on a substrate with a photoresist layer formed thereon, to simultaneously fabricate a dual convex bump and concave bump, comprising a photomask body, a first mask pattern having a first shape for the formation of the convex bump, and a second mask pattern having a second shape for the formation of the concave bump.

According to the method and photomask presented above, only one photolithography step is required to fabricate the connecting convex bump and concave bump having opposite protruding parts on a single substrate, such that the MVA display area can be divided and the disclination line can be restricted on the dual bumps. Compared to the conventional method, the presented method increases yield, lowers costs, and solves misalignment problems normally associated with bumps.

Another object of the invention is to provide a method of simultaneously fabricating a multi-thickness photoresist layer applicable on a substrate with a photoresist layer formed thereon, comprising providing a photomask having a first mask pattern for the formation of the photoresist with a first thickness having a first shape, a the second mask pattern for the formation of the photoresist with a second thickness having a second shape, and a third mask pattern for the formation of the photoresist with a third thickness having a third shape, and applying the photomask to perform photolithography on the photoresist layer.

Another object of the invention is to provide a photomask applicable on a substrate with a photoresist layer formed thereon, to simultaneously fabricate a multi-thickness photoresist layer, comprising a photomask body, a first mask pattern having a first shape for the formation of the photoresist with a first thickness, a second mask pattern having a second shape for the formation of the photoresist with a second thickness, and a third mask pattern having a third shape for the formation of the photoresist with a third thickness.

According to the method and photomask presented above, only one photolithography step is required to fabricate a multi-thickness photoresist layer having 3 different thicknesses corresponding to three-color (red, green, and blue) filters applied thereon respectively and construct the three-gap (d_{R}, d_{G}, and d_{B}) panel.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a cross-section showing a conventional MVA type LCD;

FIG. 2 shows the layout of a photomask presented in the first embodiment;

FIG. 3 is a cross-section of a photoresist after photolithography is performed thereon using the photomask shown in FIG. 2;

FIG. 4 shows the layout of a photomask presented in the second embodiment;

FIG. 5 is a cross-section of a photoresist after photolithography is performed thereon using the photomask shown in FIG. 4;

FIG. 6 is a cross-section showing a MVA type LCD in the second embodiment;

FIG. 7 is a cross-section showing an application of the second embodiment;

FIG. 8 shows the layout of a photomask presented in the third embodiment;

FIG. 9 is a cross-section showing an application of the third embodiment;

FIG. 10 shows the layout of a photomask presented in the fourth embodiment;

FIG. 11 is a cross-section showing an application of the fourth embodiment; and

FIG. 12 shows the layout of another photomask presented in the fourth embodiment.

### DETAILED DESCRIPTION OF THE INVENTION

Preferred embodiments 1˜4 of the present invention are now described with reference to FIGS. 2 to 12.

First Embodiment:

First, as in FIG. 2, a photomask 10 is provided with a first mask pattern 12 and a second mask pattern 14. The first mask pattern 12 having a first shape is made up of a plurality of light-shielding units for the formation of bumps introduced subsequently. In this embodiment, the first shape is striped. The second mask pattern 14, having a second shape, is made up of a light-shielding pattern for the formation of photospacers also introduced subsequently. In this embodiment, the second mask pattern is square with light transmittance of 0%. The light-shielding units can be polygons or circles, wherein the polygons are square, rectangular, rhomboid, or other shapes. In this embodiment, the light-shielding units are square. The light transmittance of the photomask can be adjusted by size variation or spacing arrangement of the light-shielding units.

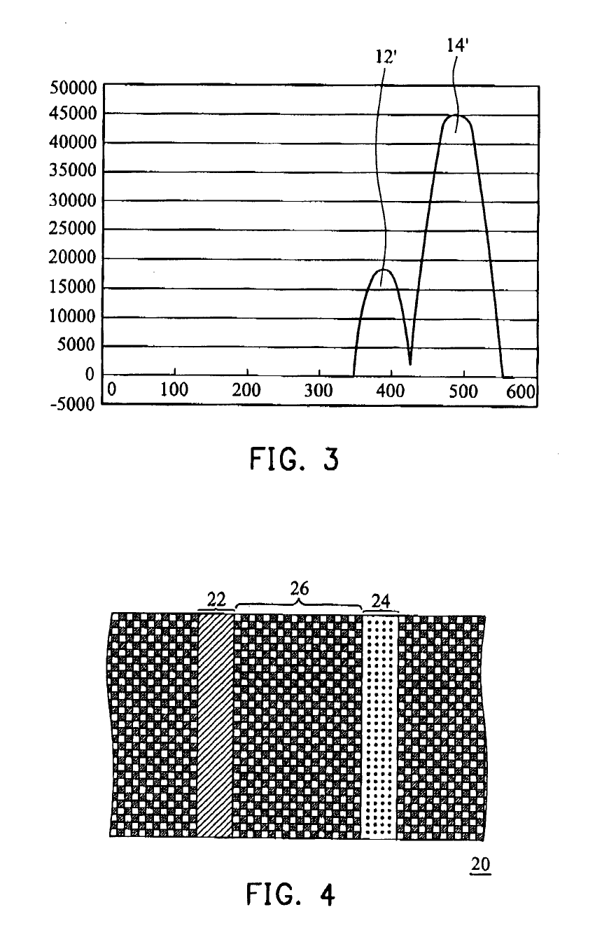

Next, the photomask 10 is applied to perform photolithography on a substrate with a photoresist layer formed thereon (not shown). The resulting formation of photoresist is shown in FIG. 3, Bumps 12′ result via the mask pattern 12, and photospacers 14′ result via the mask pattern 14.

As shown in FIG. 3, according to the method and photomask presented in the first embodiment, only one photolithography step is required to fabricate the photospacers and bumps of different thickness, such that yield is increased and cost is lowered.

Second Embodiment:

First, as in FIG. 4, a photomask 20 is provided with a first mask pattern 22, a second mask pattern 24 and a third mask pattern 26. The first mask pattern 22, having a first shape, is made up of a plurality of light-shielding units with light transmittance preferably lower than 30% for the formation of convex bumps introduced subsequently. In this embodiment, the first shape is striped and the light transmittance of first mask pattern 22 approaches 0%. The second mask pattern 24, having a second shape, is made up of a light-shielding pattern for the formation of concave bumps also introduced subsequently. In this embodiment, the second mask pattern is striped, and is made up of a plurality of light-shielding units with light transmittance preferably higher than 60%. The third mask pattern 26, having a third shape, is a matrix-formed pattern made up of a plurality of light-shielding units with light transmittance preferably between 30%-60%. The third mask pattern 26 is for the formation of flat areas between the convex and concave bumps. The light-shielding units can be polygons or circles, wherein the polygons are square, rectangular, rhomboid, or other shapes. In this embodiment, the light-shielding units are square. The light transmittance of the photomask can be adjusted by size variation or spacing arrangement of the light-shielding unite.

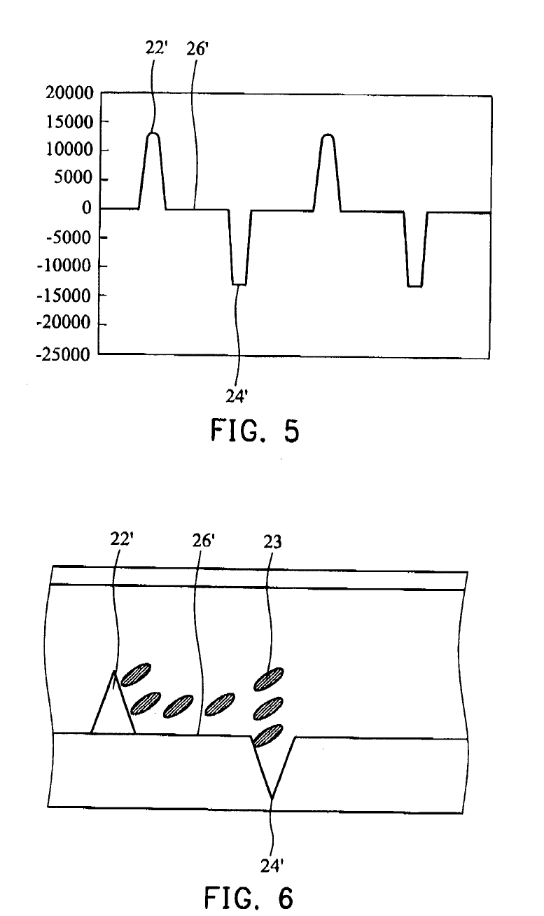

Next, the photomask 20 is applied to perform photolithography on a substrate with a photoresist layer formed thereon (not shown). The resulting formation of photoresist is shown in FIG. 5. Convex bumps 22′ result via the first mask pattern 22, concave bumps 24′ result via the second mask pattern 24, and the flat areas 26′ resulting via the third mask pattern 26 are formed between the convex bumps 22′ and the concave bumps 24′.

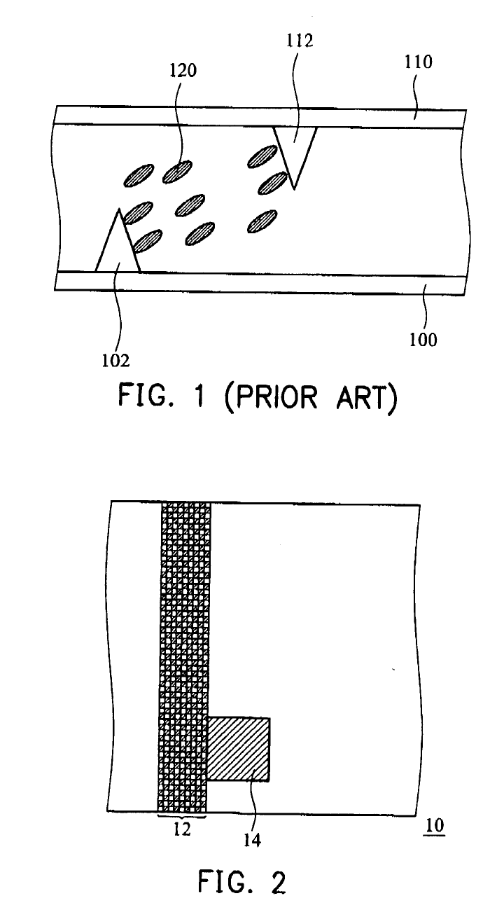

According to the method and photomask presented in the second embodiment, only one photolithography step is required to fabricate the convex bumps 22′ and concave bumps 24′ having opposite protruding parts on a single substrate. In FIG. 6, 23 are crystal molecules. Replacement of the upper bumps 112 in the conventional MVA type LCD shown in FIG. 1 by concave bumps 24′ formed according to the presented embodiment can arrange the crystal molecular orientation equivalently. Thus, ccompared to the conventional method, the invention further reduces manufacturing costs, increases yield, and solves bump misalignment problems.

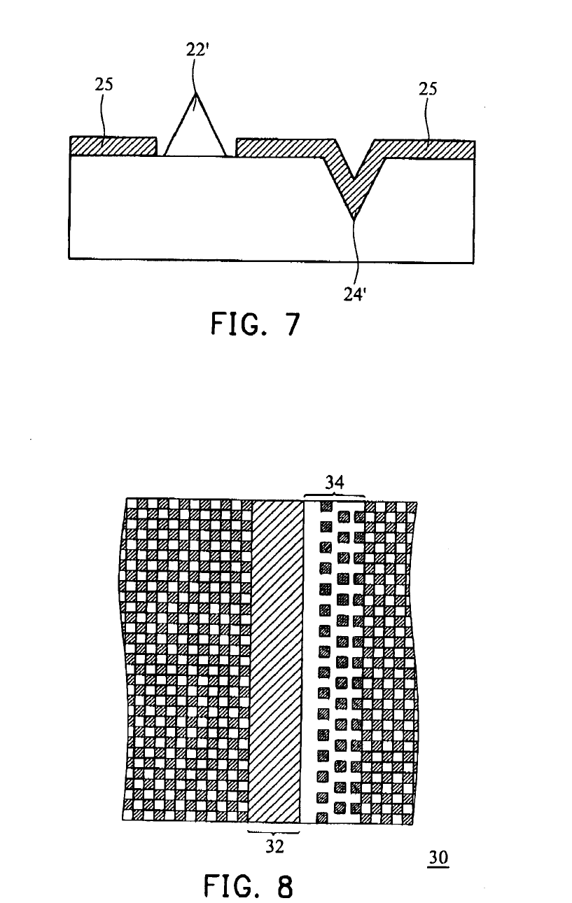

Moreover, the application of the convex and concave bumps takes place in coordination with the top-ITP process in which the ITO layer covering the convex bumps is removed while retaining that covering the concave bumps as shown in FIG. 7, wherein 25 is the ITO layer.

3rd Embodiment:

First, as shown in FIG. 8, a photomask 30 is provided with a first mask pattern 32 and a second mask pattern 34. The first mask pattern 32 having a first shape is made up of a plurality of light-shielding units with light transmittance preferably lower than 30% for the formation of convex bumps introduced subsequently. In this embodiment, the first shape is striped and the light transmittance of first mask pattern 32 approaches 0%. The second mask pattern 34, having a second shape, is made up of a light-shielding pattern for the formation of concave bumps also introduced subsequently. In this embodiment, the second mask pattern is striped, and is made up of a plurality of light-shielding units with light transmittance preferably higher than 60%. The light-shielding units can be polygons or circles, wherein the polygons are square, rectangular, rhomboid, or other shapes. In this embodiment, the light-shielding units are square. The light transmittance of the photomask can be adjusted by size variation or spacing arrangement of the light-shielding units.

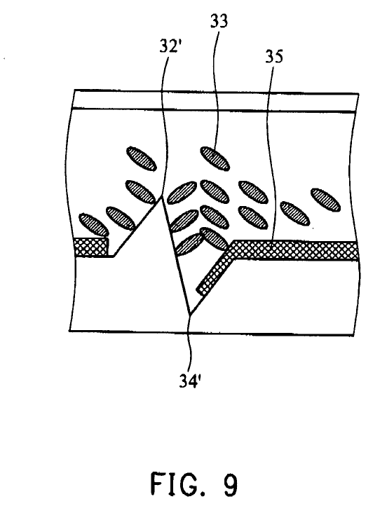

Next, the photomask 30 is applied to perform photolithography on a substrate with a photoresist layer formed thereon (not shown). The resulting formation of photoresist is shown in FIG. 9, where 33 are crystal molecules and 35 is the ITO layer. Convex bumps 32′ result via the first mask pattern 32, concave bumps 34′ result via the second mask pattern 34, and each connected pair of bumps (convex bump 32′ and concave bump 34′) is referred to as a dual bump.

According to the method and photomask presented in the third embodiment, only one photolithography step is required to fabricate dual bumps having opposite protruding parts on a single substrate. Thus, the MVA display area can be divided and the disclinaiton line can be restricted on the dual bumps. Compared to the conventional method, the presented method increases yield, lowers costs, and solves misalignment problems normally associated with bumps.

Fourth Embodiment:

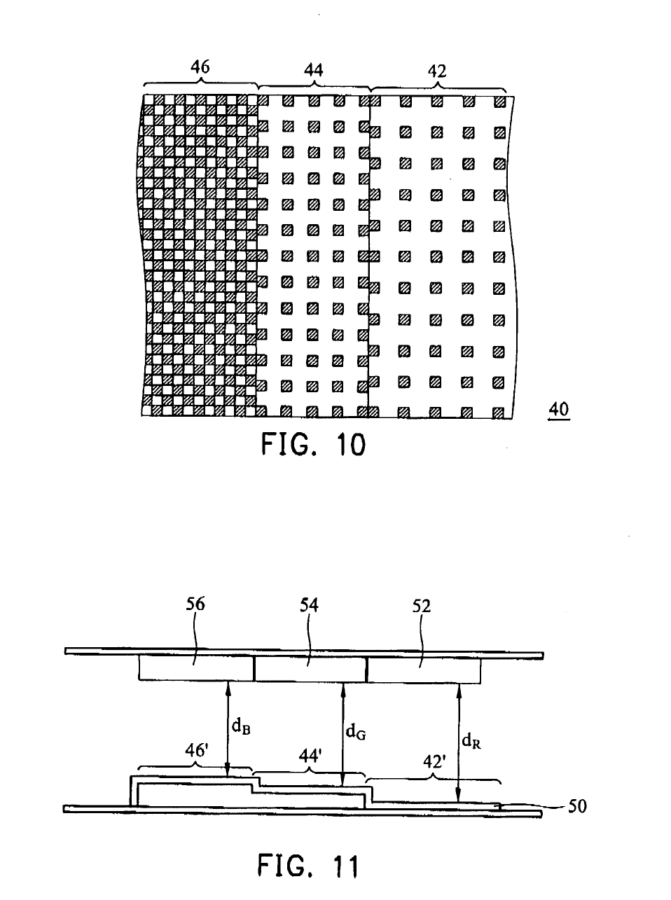

First, as in FIG. 10, a photomask 40 is provided with a first mask pattern 42, a second mask pattern 44 and a third mask pattern 46. The first mask pattern 42 having a first shape is made up of a plurality of light-shielding units with light transmittance preferably between 70%-100%, for formation of photoresist having a first thickness. In this embodiment, the first shape is a matrix-formed. The second mask pattern 44, having a second shape, is made up of a plurality of light-shielding units with light transmittance preferably between 50%-80% for the formation of photoresist having a second thickness. In this embodiment, the second shape is a matrix-formed. The third mask pattern 46, having a third shape, is made up of a plurality of light-shielding units with light transmittance preferably between 40%-70%, for formation of photoresist having a third thickness. In this embodiment, the third shape is a matrix-formed. The light-shielding units can be polygons or circles, wherein the polygons are square, rectangular, rhomboid, or other shapes. In this embodiment, the light-shielding units are square, and the first, second and third thickness comprise at least two different values. The light transmittance of the photomask can be adjusted by size variation or spacing arrangement of the light-shielding units.

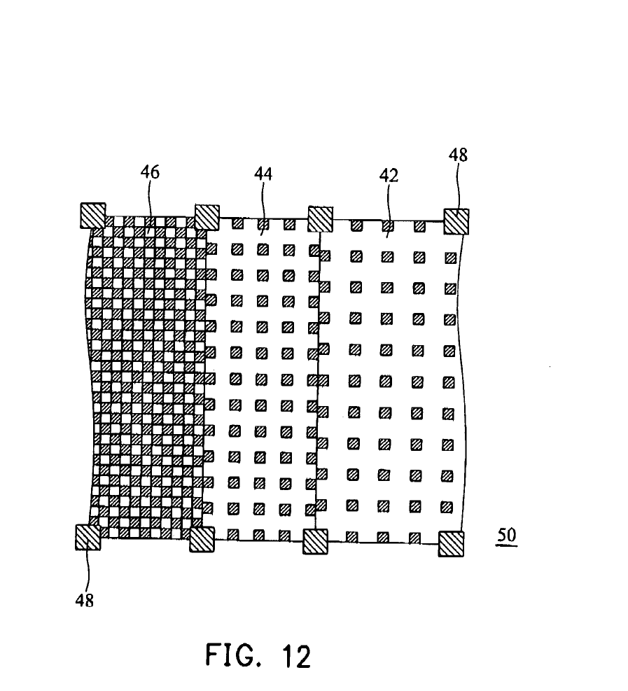

Next, the photomask 40 is applied to perform photolithography on a substrate with a photoresist layer formed thereon (not shown). The resulting formation of photoresist is shown in FIG. 11. First-thickness layer 42′ (having a thickness equaling zero in this case) results via the first mask pattern 42, second-thickness layer 44′ results via the second mask pattern 44, and the third-thickness layer 46′ results via the third mask pattern 46. In FIG. 11, 50 represents the ITO layer, 52, 54 and 56 are the red, green and blue color filters respectively, and d_{R}, d_{G}, and d_{B} are the gaps between the color filters and panel respectively.

According to the method and photomask presented in the fourth embodiment, only one photolithography step is required to fabricate a multi-thickness photoresist layer having 3 different thicknesses corresponding to the three-color (red, green, and blue) filters applied thereon respectively, and construct the three-gap (d_{R}, d_{G}, and d_{B}) panel such that adjustment of Δn_{R}*d_{R}, Δn_{G}*d_{G}, and Δn_{B}*d_{R} separately are possible, such that the best off-state mode is achievable.

Furthermore, according to the method presented in the fourth embodiment, the disadvantages of the conventional transflective LCD are improved. By means of the multi-thickness photoresist layer that can be formed by a single photolithography step, the thickness of color filters applied on the transparent area and reflective layer can be separately adjusted specifically, such that the thickness of color filter on the reflective area can be reduced while that on the transparent area is retained to maintain the purity of colors displayed in the transparent area and increase the light intensity displayed in the reflective area.

Moreover, the photomask 40 utilized in the fourth embodiment can further comprise a fourth mask pattern 48 having a fourth shape, whereby at least one photospacer can be fabricated via the photolithography step. The fourth-shaped mask pattern is, for example, a polygon or circle with light transmittance approaching 0%, wherein the polygon can be square, rectangular, rhomboid, or other shapes. In this case, the fourth mask pattern 48 is square as shown in the photomask 50 of FIG. 12.

According to the method presented in the fourth embodiment, using the photomask 50, photospacers are formed together with the multi-thickness photoresist layer ameliorating the difficulty in obtaining a LCD panel with well-controlled gap size compared to conventional methods in which spacers are sprayed randomly on the photoresist layer.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of simultaneously fabricating a photospacer and a bump applicable on a substrate with a photoresist layer formed thereon, comprising:
providing a photomask having a first mask pattern and a second mask pattern, wherein the first mask pattern having a first shape is made up of a plurality of light-shielding units for the formation of the bump, and the second mask pattern is made up of a light-shielding pattern with a second shape for the formation of the photospacer; and
applying the photomask to perform photolithography on the photoresist layer.

2. The method as claimed in claim 1, wherein the light-shielding units are polygons or circles.

3. The method as claimed in claim 2, wherein the polygon is square, rectangular, or rhomboid.

4. The method as claimed in claim 1, wherein the first shape is striped.

5. The method as claimed in claim 1, wherein the second shape is a polygon or circle.

6. The method as claimed in claim 5, wherein the polygon is square, rectangular, or rhomboid.

7. A method of simultaneously fabricating a convex bump and a concave bump having a flat area therebetween applicable on a substrate with a photoresist layer formed thereon, comprising:
providing a photomask having a first mask pattern, a second mask pattern and a third mask pattern, wherein the first mask pattern for the formation of the convex bump has a first shape, the second mask pattern for the formation of the concave bump has a second shape, and the third mask pattern for the formation of the flat area has a third shape; and
applying the photomask to perform photolithography on the photoresist layer.

8. The method as claimed in claim 7, wherein the first mask pattern is a striped light-shielding pattern made up of a plurality of light-shielding units with light transmittance lower than 30%.

9. The method as claimed in claim 7, wherein the second mask pattern is a striped light-shielding pattern made up of a plurality of light-shielding units with light transmittance higher than 60%.

10. The method as claimed in claim 7, wherein the third mask pattern is a matrix-formed light-shielding pattern made up of a plurality of light-shielding units with light transmittance between 30%-70%.

11. The method as claimed in claim 8, wherein the light-shielding units are polygons or circles.

12. The method as claimed in claim 9, wherein the light-shielding units are polygons or circles.

13. The method as claimed in claim 10, wherein the light-shielding units are polygons or circles.

14. A method of simultaneously fabricating a dual convex bump and concave bump applicable on a substrate with a photoresist layer formed thereon, comprising:
providing a photomask having a first mask pattern and a second mask pattern, wherein the first mask pattern for the formation of the convex bump has a first shape and the second mask pattern for the formation of the concave bump has a second shape; and
applying the photomask to perform photolithography on the photoresist layer.

15. The method as claimed in claim 14, wherein the first mask pattern is a striped light-shielding pattern made up of a plurality of light-shielding units with light transmittance lower than 30%.

16. The method as claimed in claim 14, wherein the second mask pattern is a striped light-shielding pattern made up of a plurality of light-shielding units with light transmittance higher than 60%.

17. The method as claimed in claim 15, wherein the light-shielding units are polygons or circles.

18. The method as claimed in claim 16, wherein the light-shielding units are polygons or circles.

19. A method of simultaneously fabricating a multi-thickness photoresist layer applicable on a substrate with a photoresist layer formed thereon, comprising;
providing a photomask having a first mask pattern, a second mask pattern and a third mask pattern, wherein the first mask pattern for the formation of the photoresist with a first thickness has a first shape, the second mask pattern for the formation of the photoresist with a second thickness has a second shape, and the third mask pattern for the formation of the photoresist with a third thickness has a third shape; and
applying the photomask to perform photolithography on the photoresist layer.

20. The method as claimed in claim 19, wherein the first mask pattern is a matrix-formed light-shielding pattern made up of a plurality of light-shielding units with light transmittance between 70%-100%.

21. The method as claimed in claim 19, wherein the second mask pattern is a matrix-formed light-shielding pattern made up of a plurality of light-shielding units with light transmittance between 50%-80%.

22. The method as claimed in claim 19, wherein the third mask pattern is a matrix-formed light-shielding pattern made up of a plurality of light-shielding units with light transmittance between 40%-70%.

23. The method as claimed in claim 20, wherein the light-shielding units are polygons or circles.

24. The method as claimed in claim 21, wherein the light-shielding units are polygons or circles.

25. The method as claimed in claim 22, wherein the light-shielding units are polygons or circles.

26. The method an claimed in claim 19, wherein the first thickness, the second thickness and the third thickness are at least two different values.

27. The method an claimed in claim 19, wherein the photomask further comprises a fourth mask pattern of a fourth shape, such that at least one photospacer is formed.

28. The method as claimed in claim 19, wherein the fourth mask pattern is a polygon or circle with light transmittance of 0%.

29. The method as claimed in claim 19, wherein the polygon is square, rectangular, or rhomboid.
